(19) United States
(12) Patent Application Publication
(10) Pub. No.: US 2012/0043925 A1
(43) Pub. Date: Feb. 23, 2012

(54) PROTECTION CIRCUIT FOR BATTERY AND BATTERY CHARGER APPARATUS USING THE SAME

(75) Inventors: YAN-LING GENG, Shenzhen City (CN); WEI HUO, Shenzhen City (CN); HUI YIN, Shenzhen City (CN); YAN XU, Shenzhen City (CN); BO-CHING LIN, Tu-Cheng (TW); HAN-CHE WANG, Tu-Cheng (TW)

(73) Assignees: HON HAI PRECISION INDUSTRY CO., LTD., Tu-Cheng (TW); HONG FU JIN PRECISION INDUSTRY ShenZhen) CO., LTD., Shenzhen City (CN)

(21) Appl. No.: 12/966,885

(22) Filed: Dec. 13, 2010

(30) Foreign Application Priority Data
Aug. 20, 2010 (CN) 201010258691.7

(51) Int. Cl. H02J 7/00; H02H 3/20

(52) U.S. Cl. 320/107; 361/91.1

(57) ABSTRACT

A protection circuit for protecting a rechargeable battery is provided. The protection circuit includes a voltage-threshold generating unit and a comparing unit. The voltage-threshold generating unit is for generating a threshold voltage. The comparing unit is for comparing the threshold voltage to the rechargeable battery voltage and outputting a charging enable signal or a charging disable signal according to the comparison result. The comparing unit outputs the charging enable signal if the amplitude of the threshold voltage is lower than that of the rechargeable battery, or outputs the charging disable signal as the amplitude of the threshold voltage is equal to or higher than that of the rechargeable battery. A battery charger apparatus using the protection circuit is also provided.

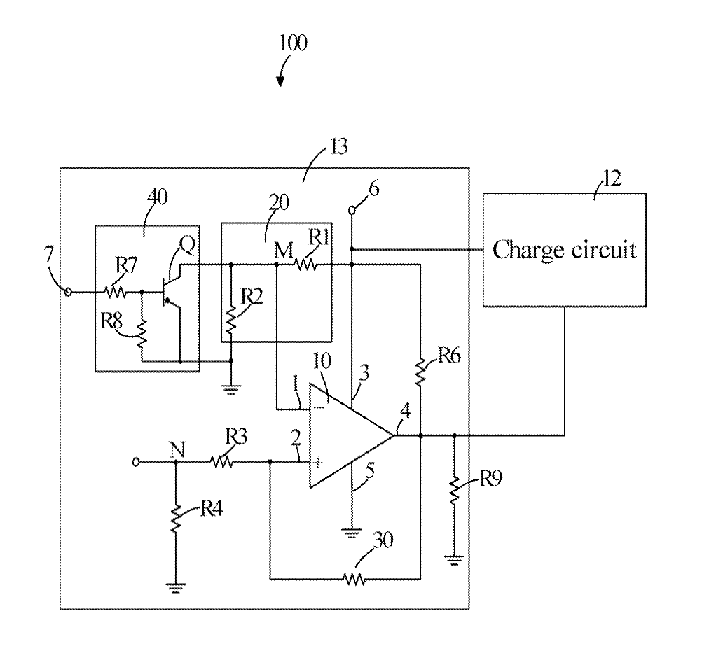

### BACKGROUND

1. Technical Field

The present disclosure relates to a protection circuit for batteries and a battery charger apparatus using the protection circuit.

2. Description of the Related Art

In known art, a rechargeable battery protection circuit is employed to protect the rechargeable battery from overcharging, overdischarging, and so forth. However, if a fully charged rechargeable battery loses even a little of its overall charge, the rechargeable battery may be necessarily re-charged once more when connected to a charging apparatus such as an adapter. This results in unnecessary frequent charging and reduces lifetime of the rechargeable battery.

Therefore, a new type of protection circuit is desired to overcome the above-mentioned shortcomings.

### BRIEF DESCRIPTION OF THE DRAWINGS

The components in the drawings are not necessarily drawn to scale, the emphasis instead being placed upon clearly illustrating the principles of a battery charge apparatus. Moreover, in the drawings, like reference numerals designate corresponding parts throughout the several views.

The FIGURE is a circuit diagram of a battery charger apparatus in accordance with an exemplary embodiment.

### DETAILED DESCRIPTION

Referring to the FIGURE, a battery charger apparatus 100 includes a charge circuit 12 and a protection circuit 13. The charge circuit 12 receives power, such as +110V DC power, through a power input port 6, and charges a rechargeable battery (not shown) electrically connected thereto. The protection circuit 13 enables or disables the charge circuit 12 according to the battery voltage of the rechargeable battery. In the embodiment, the battery charger apparatus 100 is a power adapter or a battery charger.

The protection circuit 13 includes a voltage-threshold generating unit 20, a comparing unit 10, a feedback unit 30, and a reset unit 40. The voltage-threshold generating unit 20 is configured for receiving power through the power input port 6, and generates a threshold voltage. The comparing unit 10 is configured for comparing the threshold voltage with the battery voltage and generates a charging enable signal or a charging disable signal according to the comparison. In this way a threshold voltage can be set that prevents battery charging from occurring when there is only a minor difference between actual charge of a battery and full capacity. The feedback unit 30 is configured for feeding back the charging enable signal or the charging disable signal to the comparing unit 10. During the charging process of the rechargeable battery, the comparing unit 10 continuously outputs the charging enable signal according to the feed back charging enable signal, or continuously outputs the charging disable signal according to the feed back charging disable signal.

In the embodiment, the voltage-threshold generating unit 20 includes a first resistor R1 and a second resistor R2 connected in series. One end of the first resistor R1 is connected to the power input port 6 and the other end is connected the resistor R2 to form a first node M between the first resistor R1 and the second resistor R2. The second resistor R2 is connected between the first node and the ground. One input port of the comparing unit 10 is connected to the first node. The threshold voltage is the voltage drop across the resistor R1. In an alternative embodiment, the voltage-threshold generating unit 20 is a rheostat. In the other alternative embodiment, the resistor R1 or R2 is a rheostat, or both resistor R1 and R2 are rheostats for providing an adjustable threshold voltage to the comparing unit 10, for use with different types of batteries.

The comparing unit 10 receives the threshold voltage through a first input port 1 and the battery voltage through a second input port 2, and then outputs the charging enable signal or the charging disable signal through an output port 4. The charging enable signal is output to the charge circuit 12 on the condition that the amplitude of the threshold voltage is lower than that of the battery voltage; and the charging disable signal is output to the charge circuit 12 on the condition that the amplitude of the threshold voltage is equal to or higher than that of the battery voltage. In the embodiment, the output port 4 is also grounded via a resistor R9, the charging enable signal is a low level signal, and the charging disable signal is a high level signal. The comparing unit 10 is a hysteresis comparator that also includes a power input port 3 for receiving power and a grounding terminal 5.

The charge circuit 12 is activated to charge the rechargeable battery in response to the charging enable signal, and does not charge the rechargeable battery or stops charging the rechargeable battery in response to the charging disable signal.

The second input port 2 of the comparing unit 10 is also grounded through a third resistor R3 and a fourth resistor R4 connected in series. The battery voltage is transmitted to the comparing unit 10 via a second node N between the third resistor R3 and the fourth resistor R4.

The feedback unit 30 is connected between the second input port 2 and the output port 4. In the embodiment, the feedback unit 30 is a resistor. A sixth resistor R6 is connected between the power input port 3 and the output port 4.

The reset unit 40 is configured for resetting the comparing unit 10 and includes an NPN type transistor Q, a seventh resistor R7, and an eighth resistor R8. The reset unit 40 resets the comparing unit 10 in response to a pulse signal through an input terminal 7. In the embodiment, the resetting signal is a high-level pulse, which is supplied by an electronic apparatus (not shown). The base of the transistor Q is connected to the input terminal 7 through the seventh resistor R7, the collector is connected to the node M, and the emitter is grounded. The eighth resistor R8 is connected between the base and the emitter of the transistor Q.

With such configuration, the battery voltage is input to the second input port 2 of the comparing unit 10 after the rechargeable battery voltage is connected to the apparatus 100. The comparing unit 10 outputs the charging enable signal to the charge circuit 12 if the rechargeable battery voltage is lower than the threshold voltage. The charge unit circuit 12 charges the rechargeable battery in response to the charging enable signal. The comparing unit 10 outputs the charging disable signal to the charge circuit 12 if the rechargeable battery voltage is equal to or higher than the threshold voltage. The charge unit circuit 12 does not charge the rechargeable battery or stops charging the rechargeable battery in response to the charging disable signal.

When a high-level pulse is input to the reset unit 40 through the input terminal 7, the transistor Q is turned on in response to the high-level pulse, which results in the first node M being grounded. Therefore, the first input port 1 is grounded via the first node M. The comparing unit 10 is reset to restart the apparatus 100 when the apparatus 100 goes into an endless loop.

It is understood that the disclosure may be embodied in other forms without departing from the spirit thereof. Thus, the present examples and embodiments are to be considered in all respects as illustrative and not restrictive, and the disclosure is not to be limited to the details given herein.

What is claimed is:

1. A protection circuit applied in a battery charging apparatus for protecting a rechargeable battery, comprising:
a voltage-threshold generating unit for generating a threshold voltage; and
a comparing unit for comparing the threshold voltage with a battery voltage of the rechargeable battery and outputting a charging enable signal or a charging disable signal according to the comparison result; wherein the comparing unit outputs the charging enable signal if the amplitude of the threshold voltage is lower than that of the rechargeable battery, or outputs the charging disable signal as the amplitude of the threshold voltage is equal to or higher than that of the rechargeable battery.

2. The protection circuit as claimed in claim 1, further comprising a feedback unit for feeding back the charging enable signal or the charging disable signal to the comparing unit.

3. The protection circuit as claimed in claim 1, wherein the voltage-threshold generating unit comprising a first resistance component and a second resistance component connected in series, one end of the first resistance component is connected to a power input port and the other end is connected the second resistance component to form a first node between the first resistance component and the second resistance component, the second resistance component is connected between the first node and the ground, the threshold voltage is the voltage drop across the first resistance component, the comparing unit is connected to the first node to receive the threshold voltage.

4. The protection circuit as claimed in claim 1, wherein the voltage-threshold generating unit is a rheostat.

5. The protection circuit as claimed in claim 3, wherein the first resistance component or the second resistance component is a rheostat, or both of the first resistance component and the second resistance component are rheostats.

6. The protection circuit as claimed in claim 1, wherein the comparing unit is a hysteresis comparator, which comprises a first input port, a second input port and an output port; the first input port is for receiving the threshold voltage, the second input port is for receiving the battery voltage of the rechargeable battery, and the output port is for outputting the charging enable signal or the charging disable signal.

7. The protection circuit as claimed in claim 1, further comprising a reset unit for resetting the compare unit.

8. The protection circuit as claimed in claim 7, wherein the reset unit comprising an NPN transistor and a seventh resistance component, and an eighth resistance component connected between the base and the emitter of the transistor, the base of the transistor is connected to the seventh resistance component, the collector is connected to the first node, and the emitter is grounded.

9. The protection circuit as claimed in claim 6, wherein the output port is grounded through a resistance component, and the charging enable signal is a low level signal and the charging disable signal is a high level signal.

10. A battery charger apparatus for protecting a rechargeable battery comprising:
a protection circuit comprising:
a voltage-threshold generating unit for generating a threshold voltage; and
a comparing unit for comparing the threshold voltage with a battery voltage of the rechargeable battery and outputting a charging enable signal or a charging disable signal according to the comparison result; wherein the comparing unit outputs the charging enable signal if the amplitude of the threshold voltage is lower than that of the rechargeable battery, or outputs the charging disable signal as the amplitude of the threshold voltage is equal to or higher than that of the rechargeable battery; and
a charging circuit for charging the rechargeable battery in response to the charging enable signal, and not charging the rechargeable battery or stopping charging the rechargeable battery in response to the charging disable signal.

11. The battery charger apparatus as claimed in claim 10, wherein the protection control circuit further comprising a feedback unit for feeding back the charging enable signal or the charging disable signal to the comparing unit.

12. The battery charger apparatus as claimed in claim 10, wherein the voltage-threshold generating unit comprising a first resistance component and a second resistance component connected in series, one end of the first resistance component is connected to a power input port and the other end is connected the second resistance component to form a first node between the first resistance component and the second resistance component, the second resistance component is connected between the first node and the ground, the threshold voltage is the voltage drop across the first resistance component, the comparing unit is connected to the first node to receive the threshold voltage.

13. The battery charger apparatus as claimed in claim 10, wherein the voltage-threshold generating unit is a rheostat.

14. The battery charger apparatus as claimed in claim 12, wherein the first resistance component or the second resistance component is a rheostat, or both of the first resistance component and the second resistance component are rheostat.

15. The battery charger apparatus as claimed in claim 10, wherein the comparing unit is a hysteresis comparator, which comprises a first input port, a second input port and an output port; the first input port is for receiving the threshold voltage, the second input port is for receiving the battery voltage of the rechargeable battery, and the output port is for outputting the charging enable signal or the charging disable signal.

16. The battery charger apparatus as claimed in claim 10, wherein the protection circuit further comprising a reset unit for resetting the battery charging apparatus.

17. The battery charger apparatus as claimed in claim 16, wherein the reset unit comprising an NPN transistor and a seventh resistance component, and an eighth resistance component connected between the base and the emitter of the transistor, the base of the transistor is connected to the seventh resistance component, the collector is connected to the first node, and the emitter is grounded.

18. The battery charger apparatus as claimed in claim 15, wherein the output port is grounded through a resistance component, and the charging enable signal is a low level signal and the charging disable signal is a high level signal.
